(19) United States
(12) Patent Application Publication
(10) Pub. No.: US 2003/0198800 A1
(43) Pub. Date: Oct. 23, 2003

(54) Plastic element for the confinement of HF reflections

(76) Inventor: Peter Hoffman, Schwerre (DE)

Correspondence Address: KATTEN MUCHIN ZAVIS ROSENMAN, 575 MADISON AVENUE, NEW YORK, NY, 10022-2585, US

(21) Appl. No.: 10/449,585

(22) Filed: May 29, 2003

Related U.S. Application Data
(62) Division of application No. 09/655,640, filed on Sep. 5, 2000.
Application No. 09/655,640 is a continuation-in-part of application No. 09/380,533, filed on Sep. 1, 1999, now abandoned.
Application No. 09/380,533 is a 371 of international application No. PCT/EP98/01013, filed on Feb. 21, 1998.

(30) Foreign Application Priority Data
Feb. 21, 1998 (DE) 297 03 725.0

(51) Int. Cl. B32B 5/16

(52) U.S. Cl. 428/323; 428/423.1

(57) ABSTRACT

A sheet like plastic element confines reflections of high-frequency (HF) radiation in HF-shielded areas such as places where computers are installed, HF-shielded chambers or the like. Specially, it provides a solution by which the corresponding chamber lining can be made more lightweight and inexpensive with the same damping or shielding effect. The sheet like plastic element is made by the high-frequency radiation-scattering particles, especially, electrically conducting particles, being enclosed in the backing plastic in such a way that there is neither transverse nor longitudinal electrical conduction through the plastic element.

### RELATED APPLICATIONS

This is a divisional application of pending U.S. application Ser. No. 09/655,640 filed Sep. 5, 2002, which is a continuation-in-part of U.S. patent application Ser. No. 09/380,533, filed on Sep. 1, 1999, now abandoned.

### FIELD OF THE INVENTION

The present invention relates to a plastic element, and more particularly, to a sheet like plastic element for the confinement of reflections of high-frequency radiation in HF-shielded areas.

### BACKGROUND OF THE INVENTION

To obtain comparatively accurate measuring results in connection with the examination of objects emitting high-frequency radiation, they are examined in measuring chambers in which the walls are provided with a covering that does not reflect the high-frequency radiation or only to an extremely small extent. Such a covering generally comprises ferrite tiles, which are capable of absorbing incident high-frequency (from now on HF) radiation. The ferrite tiles are adhesively attached, or fastened in some other way, onto metal walls of the measuring chamber, forming a Faraday cage and consequently the HF shielding. Such a covering is not only relatively heavy, which influences the statics of such chambers; it is also comparatively expensive.

A shielding means for shielding against static electric fields in the form of a multilayered sheet is known from DE-37 07 238-A1, where a powder of conductive material is incorporated in plastic foam. The specific avoidance of transverse and longitudinal electrical conduction achieved by the plastic is not disclosed by this literature reference. Shielding panels or sheets are described in other prior literature references, special means for shielding also being known from the prior art, for instance DT-20 26 890, DE-A1 publications 34 17 895, 39 00 856, 40 03 908, 40 26 403, 41 01 869, 42 43 368, 43 24 916, 43 35 626 or 195 18 541-C2.

The literature references cited above generally have in common that they attempt to provide electrically conducting plastics to achieve the advantages respectively described.

### SUMMARY OF THE INVENTION

The situation is different in the case of the invention, the object of which is to provide a solution by which the corresponding chamber lining can be made more lightweight and, in particular, inexpensive with the same damping or shielding effect. With a plastic element, in particular a sheet like element, of the type referred to at the beginning, this object is achieved by electrically conducting particles being enclosed in the plastic in such a way that there is neither transverse nor longitudinal electrical conduction through the plastic element.

A solution to the set object is also achieved by a production process with the use of polyurethane as a backing plastic, which is distinguished in that a pasty substrate of metal powder, graphite powder and the polyol component is produced, the diisocyanate component is subsequently fed in and the mixture is made to expand.

It is advantageous if some of the electrical particles comprise essentially metal powder, in particular iron powder, while others may comprise graphite powder. In addition to these particles, it is also possible, according to the present invention, to form the particles from manganese, zinc and/or nickel, a particularly advantageous development of the present invention being that the embedded electrical particles have a crystalline structure for diffuse scattering within the material. According to the invention, this can be achieved for example by the metal powder being sprayed with water and not discharged in an inert gas atmosphere during its production, so that the water-sprayed particles have crystalline surfaces as compared with the inert-gas-sprayed particles, which generally have a shape closely resembling a spherical shape and no longer allow diffuse reflections, as is desired according to the invention.

Of the total amount of embedded particles present as additives in the plastic, the iron powder may constitute up to about 90%. As already stated above, the remainder may comprise, for example, manganese, zinc and/or nickel powders, or a composite thereof. It should be expressly mentioned at this point that the invention is not restricted to these specified amounts, it also being possible for the amounts to be distributed in some other way within the plastic.

A corresponding sheet like element is particularly inexpensive if polyurethane is provided, for example, as the backing plastic. Synthetic resins or the like may of course also be used if so desired for certain reasons. Polyurethane has the special advantages associated with this plastic; it is lightweight, easy to process and, in particular, easy to mold.

In accordance with preferred embodiments of the present invention, the sheet like elements may be designed in the form of panels, but also as strips or roll material or as geometrically comparatively small plates, i.e. of the size of tiles.

One advantage of the invention is that a corresponding plastic element has a high dielectric strength (>10 kV/mm), the electrically conducting particles being completely enclosed, so that they can fully bring to bear their three-dimensional properties. High-purity carbon used absorbs deeply penetrating high-frequency radiation, in this case by conversion into heat. The abstraction capability is around >20 dBTL on average and an effectiveness of about 15 MHz into about 3 GHz range.

The use of rigid polyurethane foam, which usually forms a defined bubble size, produces a high effectiveness at frequencies above 600 MHz, it being possible, according to the invention, for this operation to be influenced and controlled in high-pressure molds of different sizes during the production process. In comparison with known ferrite materials, a sheet like element according to the present invention has a number of advantages:

1 cm³ weighs less than 0.2 g (ferrite 5.0 g/cm³). The low weight means that no equipment is damaged during transit;

it is not conductive and can consequently be used on live elements as a damping material without insulation;

it is easy to install and has no environmental impact;

production can be carried out with the simplest means;

it can be used in anechoic chambers for reflection damping and in electrical and electronic equipment for interference suppression;

the low weight has the effect of reducing transport costs.

### BRIEF DESCRIPTION OF THE DRAWINGS

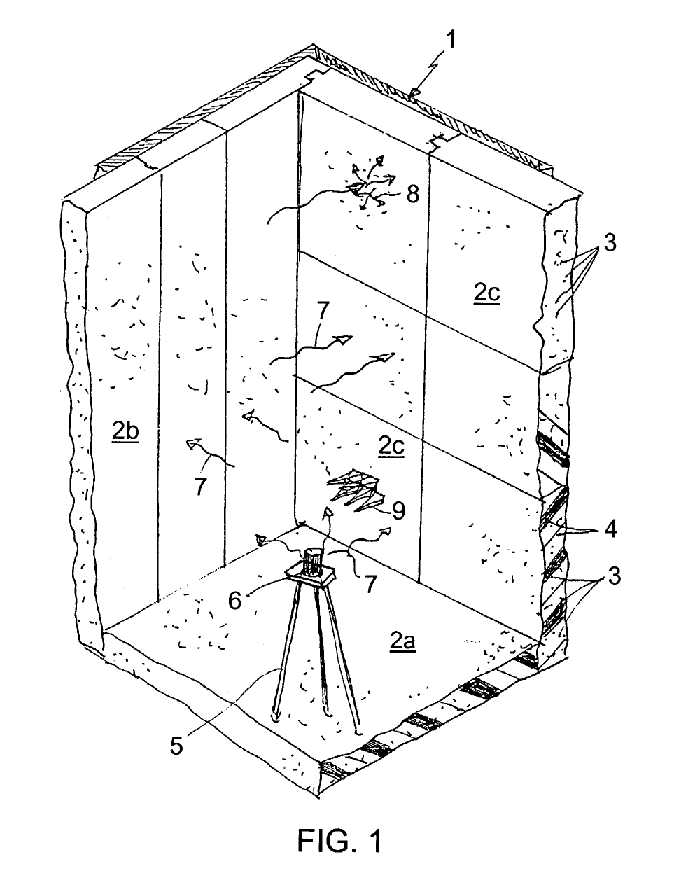

The above and other objects and features of the present invention will become apparent from the following description of preferred embodiments given in conjunction with the accompanying FIG. 1, which shows the corner of a shielding chamber in a simplified representation.

### DETAILED DESCRIPTION OF THE PREFERRED EMBODIMENTS

In the example represented in the accompanying FIG. 1, the corner of a metal shielding generally denoted by 1 is lined toward the interior of the chamber with sheet like elements in accordance with the present invention, three variants being shown here, namely a comparatively large-area bottom panel 2a, strip or roll sheet like elements 2b on one wall side and sheet like elements 2c in tile form on the other wall side, which serve here merely as examples and are not intended to restrict the invention. The electrically conducting particles 3 are intended to be represented in the panels by dots, shading 4 being intended to illustrate that these are particles 3 embedded in the plastic. Indicated on the bottom panel 2a is a tripod 5 with a test piece 6 emitting HF radiation, the emanating HF radiation being indicated by wavy arrows 7. In the upper region of the figure, the incidence of such HF radiation on particles is indicated, small arrows 8 in the interior of the panels being intended to indicate a diffuse reflected radiation. Finally, on one tile 2c there is also indicated the possibility of providing reflection pyramids 9 which are known and do not represent a special feature of the present invention. Hereinafter, the producing process of the inventive plastic element in accordance with the present invention will be illustrated.

First, in accordance with a preferred embodiment of the present invention, the backing plastic in which the electrically conducting particles are embedded is basically polyurethane constituted by two components of polyol and diisocyanate. Both components are volatile, the mixing ratio is about 100:60. The expansion is carried out at room temperature plus about 15° C., but not over 35° C. in closed molds with outlet openings.

The impurities, i.e., the electrically conducting particles, to be stirred into the non-active component of the polyurethane are metals and oxides in a natural state. An important part of the present invention is that the metals do not have to be treated, but are obtained from the manufacturer as powder in a crystalline form and are processed in this form.

In accordance with various embodiments of the present invention, the particles can be selected from the following group.

The constituents of the group are as follows:

| | |
|---|---|
| FEC 35, iron powder crystalline with a very high | Grain size <0.2 mm |
| proportion of plastic | |
| FeMn, manganese powder crystalline with 20% iron | Grain size <0.2 mm |
| content | |
| zinc powder pure fine | Grain size <0.1 mm |
| nickel crystalline powder pure | Grain size <0.2 mm |
| iron nickel 50/50 | Grain size <0.2 mm |
| Iron oxide powder fine | Grain size <0.1 mm |
| Aluminum oxides coarse | Grain size <1.0 mm |

By varying the individual particle sizes and composition of the individual materials, the broadband nature of the absorption is established. For example, with a mixture of iron and ferromanganese with very coarse particles, magnetic fields in the kHz range can be damped very well.

Through the use of the polyurethane and the particles, the plastic element of the present invention is made according to the following procedure.

First of all, the defined metal powders, e.g., 20 kg of carbon and 20 kg of iron-manganese/m³ (herein, iron, nickel or zinc are also used depending on the frequency response), are homogeneously mixed with polyol. This very viscous mass is mixed in a second mixing operation with the diisocyanate (the reaction is triggered by diisocyanate, which reacts with H₂O fractions in the polyol and thereby starts the expansion) and must then be introduced within 15 seconds into a pressure-sealed stable mold, in which it immediately starts expanding. Then, the finished material can be cut with a saw to any desired size and shape.

In the above, the particles are mixed with the backing plastic in such a way that there is neither transverse nor longitudinal electrical conduction through the plastic element. Further, the mold is designed in such a way that the expanding mass cannot get out; but gases produced can indeed escape.

The function of the inventive plastic element is as follows.

When the high-frequency wave meets the surface of the plastic element, it is directed inward and absorbed completely. The homogeneous distribution of the metal particles causes oppositely acting fields to occur at the ferromagnetic particles, neutralizing some of the incident energy. The still free energy is reflected in the voids of the foam, until the process referred to above causes the energy content to approach 0. The high density of the metal particles has the effect that the unit likewise takes the form of a capacitor, which discharges to the shielding.

The present invention is based on joining together these normally only reflective materials, which are obtained from the above producing process, without additional treatment to form an HF-absorbent mixture, so that they provide a unit which is not electrically conductive and are effective in a broadband range. Consequently, there is also a distinction between the near field and the remote field. The aluminum oxide is omitted and the proportions of iron powder are increased. The level of the absorption frequency is determined by increasing the nickel zinc fraction.

The present invention is further based on succeeding for the first time in providing a broadband, non-conductive plastics material which absorbs high-frequency radiation from about 15 MHz to about 3 GHz, so that compliance is achieved with the standards for absorber chambers and absorber cubicles. The values for this are as specified above. Interference suppression can be easily provided for electrical and electronic equipment by connecting up to the control unit.

The described exemplary embodiments of the present invention can of course be modified in many respects without departing from the basic idea. The invention is therefore not restricted either to the particular three-dimensional shaping of the individual sheet like elements, or to the way in which they are joined together by tongue and groove joints or the like or to specific metallic powders embedded in plastic, or indeed to particular plastics.

I claim:

1. A plastic element for the confinement of reflections of high-frequency (HF) radiation in HF-shielded areas, comprising:
HF radiation-scattering particles provided in a plastic backing,
said particles being electrically conducting,
wherein said particles are embedded in the plastic backing in such a way that there is neither transverse nor longitudinal electrical conduction through the plastic element.

2. The plastic element as recited in claim 1, wherein the particles are electrically conductive and selected from a group consisting of metals, oxides and a composite thereof in the form of powder.

3. The plastic element as recited in claim 2, wherein the metals are selected from a group consisting of iron, graphite, manganese, zinc, and nickel.

4. The plastic element as recited in claim 2, wherein the oxides are aluminum oxides.

5. The plastic element as recited in claim 3, wherein the iron power constitutes up to about 90% of the total number of the particles.

6. The plastic element as recited in claim 1, wherein the particles have a crystalline structure for diffuse scattering.

7. The plastic element as recited in claim 1, wherein the plastic backing is polyurethane whose components are polyol and diisocyanate.

8. The plastic element as recited in claim 1, wherein the plastic element is designed as a sheet like element in the form of panels, strips, roll material or tiles.

9. The plastic element as recited in claim 1, wherein the high-frequency ranges from about 15 MHz to about 3 GHz.

10. An electrically insulating plastic body for limiting reflections of high-frequency (HF) radiation in HF-shielded zones, comprising:
electrically conductive particles that scatter HF radiation,
said particles being completely embedded in the plastic body, and said particles being provided with a crystalline structure produced by atomization with water.

11. The plastic body according to claim 10, wherein iron powder comprises part of the electrically conductive particles.

12. The plastic body according to claim 10, wherein graphite powder comprises part of the electrically conductive particles.

13. The plastic body according to claim 10, wherein the electrically conductive particles are formed from manganese, zinc and/or nickel.

14. The plastic body according to claim 10, wherein the plastic body is formed from polyurethane.

15. The plastic body according to claim 10, wherein the plastic body is constructed as a flat element in the form of plates, strips, rolls and/or tiles.
